(19) United States
(12) Patent Application Publication
(10) Pub. No.: US 2007/0101132 A1
(43) Pub. Date: May 3, 2007

(54) Method and device for forming an encrypted message together with method and device for encrypting an encrypted message

(75) Inventors: Jorge Cuellar, Baierbrunn (DE); Hannes Tschofenig, Munich (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, München (DE)

(21) Appl. No.: 10/561,207

(22) PCT Filed: Jun. 17, 2004
(86) PCT No.: PCT/EP04/51153

§ 371 Date: Nov. 3, 2006

(30) Foreign Application Priority Data
Jun. 18, 2003 (DE) 103 27 610.6

(51) Int. Cl. H04L 9/00

(52) U.S. Cl. 713/168; 713/171

(57) ABSTRACT

A cryptographic key pair is formed using an Internet-based authentication method, in order to transmit communication configuration data from a first communication unit to a second communication unit in a secure cryptographic manner.

### CLAIM FOR PRIORITY

This application is a national stage of PCT/EP2004/051153 which was published on Jan. 13, 2005 and which claims the benefit of priority to German Application No. 10327610.6 filed Jun. 18, 2003.

### TECHNICAL FIELD OF THE INVENTION

The invention relates to a method and device for forming an encrypted message, and to a method and device for encrypting an encrypted message.

### BACKGROUND OF THE INVENTION

While accessing a network, a mobile radio communication terminal usually receives a series of configuration parameters from the communication network, including for instance communication connection parameters. The mechanism used in providing the configuration parameters depends on the application scenario concerned.

For a mobile radio communication terminal that logs into a local network such as a wireless local area network (WLAN), using for example what is known as a hotspot as the access node to the local network, the option to provide configuration parameters is frequently not available at present, since neither point-to-point protocol (PPP) nor a virtual private network (VPN) are used. If there is no protection for the configuration data used by the mobile radio communication terminal concerned, that is to say, for the configuration parameters, a hacker has the opportunity to cause harm both to the mobile radio communication terminal and to the communication network. A description of the existing security threats can be found for example in [1].

FIG. 1 shows a block diagram of a communication system 100. The communication system 100 has an access network 101 and a network domain 102 which are coupled together by means of an access router 105.

Furthermore at least one mobile radio communication terminal 103 and a link node 104 are provided in the access network 101, in order to provide a mobile radio communication link between the mobile radio communication terminal 103 and the network domain 102 and from there to other communication terminals.

FIG. 1 also shows a plurality of essential communication protocols which are executed in the context of a communication network access procedure. The single and double-ended arrows indicate in each case the entities of the communication instances concerned between which the respective communication protocol is executed.

Thus a protocol for providing the communication network domains security is provided between the communication network domain 102 and the access router 105, indicated by a first arrow 106 (1. Network Domain Security in FIG. 1).

Moreover a secure IP address configuration is provided in the context of a second communication protocol, shown in FIG. 1 by a second arrow 107 (2. Secure IP Address Configuration in FIG. 1).

An authentication and security association between on the one hand the mobile radio communication terminal 103 and the access router 105 and on the other hand between the access router 105 and the communication network domain 102 is established by using the mobile radio communication terminal 103, the link node 104 and the access router 105, represented in FIG. 1 by a third arrow 108 and a fourth arrow 109 (3. Authentication and Security Association Establishment in FIG. 1).

It is also usually the case that the communication protocols provided are situated at the layer 2 level of the open systems interconnection (OSI) reference model, that is, the layer for providing security mechanisms at the level of the data security layer, indicated in FIG. 1 by a fifth arrow 110 between the mobile radio communication terminal 103 and the link node 104, or by a sixth arrow 111 for protecting the communication at the level of the data security layer between the link node 104 and the access router 105.

A seventh arrow 112 represents a further communication protocol for providing security mechanisms at the level of the Internet protocol layer between the mobile radio communication terminal 103 and the access router 105.

Of particular significance throughout the present document are the communication protocols for ensuring secure IP address configuration (represented by the second arrow 107) and for authentication and security association establishment (represented by the third arrow 108 and the fourth arrow 109).

A known method for the provision of configuration parameters in the context of business communication networks is to configure said parameters either statically or dynamically, for example according to the dynamic host configuration protocol for IPv6 (DHCPv6), as described in [2] or [3]).

Even in [2] and [3] there is no provision for cryptographic protection of the respective communication protocols they describe. However, DHCP offers the possibility of securing electronic messages in the communication protocol by means of a previously negotiated cryptographic key. This possibility is described in [4].

At the present time point-to-point protocol (PPP) or a variation known as point-to-point protocol over Ethernet (PPPoE) is used almost exclusively for accessing an Internet service provider and transmitting the necessary configuration parameters to the mobile radio communication terminal.

Known methods for accessing a virtual private network (VPN) involve using two protocols, namely a first protocol ModeConfig and/or a second communication protocol DHCP, to transport the configuration parameters for a mobile radio communication terminal, that is, its configuration data, in a cryptographically protected manner. Said protocols are described in [5], [6], [7] and [8].

In the case of the ModeConfig communication protocol [lacuna] were integrated in the authentication and key negotiation protocol known as Internet key exchange (IKE), described in [9], and/or in the Internet key exchange v2 protocol (IKEv2), described in [10].

Different methods have been used in the past to enable the cryptographically protected transmission of configuration parameters between a communication network and a mobile radio communication terminal.

These methods can be divided into three main groups:
1. Enhancements to DHCP:
   A series of enhancements to DHCP for the cryptographic protection of DHCP messages in the environs of mobile radio communication terminals have been proposed, as described for instance in [11], [12], [13] and [14].
   These enhancements to DHCP are intended to enable a mobile radio communication terminal to dynamically establish in the communication network a security association with the DHCP server.
2. Enhancements to the extensible authentication protocol (EAP) method:
   The extensible authentication protocol is described in [16].
   An enhancement to an EAP method is described in [15]. This is designed to enable the internet key exchange protocol v2, as described in [10], to be reused.
   As a side effect IKEv2 includes the ability to transmit configuration parameters in a cryptographically protected manner.
3. Bootstrapping methods:
   In a known proposal concerning a communication protocol, the initial network authentication is enabled by using EAP and providing a secure communication link to the DHCP server (cf. [17]).
   The advantage of this method is the separation between the network authentication and the cryptographic security of the DHCP messages.
   In this case the DHCP communication protocol does not need to be modified.

A method for EAP authorization is described in [18].

Further enhancements to the extensible authentication protocol for cryptographically secure data transmission are described in [19], [20] and [21].

### SUMMARY OF THE INVENTION

The invention resolves the problem of finding a simple way to provide cryptographically secure communication configuration data to a communication terminal.

In one embodiment of the invention, there is a method and a device for forming an encrypted message, and a method and a device for encrypting an encrypted.

The embodiments of the invention which are described below relate not only to the method and the device for forming an encrypted message but also to the method and the device for encrypting an encrypted message.

The components of the invention which are described below can be produced in the form of software, that is, by means of a computer program, in the form of hardware, that is, by means of a special electrical circuit, or in any hybrid form, that is, partly in hardware and partly in software.

In one embodiment of the invention, there is a method for forming an encrypted message whereby the encrypted message includes communication configuration data, an Internet-based authentication method is executed by using at least one service from a unit in a security layer (or link control layer) between a first communication unit and a second communication unit, so that at least one pair of cryptographic keys, having at least two keys corresponding cryptographically to one another, is formed for the first communication unit and for the second communication unit. The communication configuration data of the first communication unit is encrypted using at least one cryptographic key of the at least one pair of cryptographic keys, thus forming the encrypted message.

In a method for decrypting an encrypted message whereby the encrypted message includes communication configuration data, an Internet-based authentication method is executed by using at least one service from a unit in a security layer between a first communication unit and a second communication unit, so that at least one pair of cryptographic keys is formed for the first communication unit and for the second communication unit. The communication configuration data of the second communication unit, included in the encrypted message, is determined by decryption using at least one cryptographic key of the at least one pair of cryptographic keys.

In another embodiment of the invention, there is a device for forming an encrypted message, whereby the encrypted message includes communication configuration data, has a key generation unit which is able to execute an Internet-based authentication method by using at least one service from a unit in a security layer between a first communication unit and a second communication unit, so that at least one pair of cryptographic keys is formed for the first communication unit and for the second communication unit. Furthermore the device has an encryption unit which is able to encrypt the communication configuration data by using at least one cryptographic key of the at least one pair of cryptographic keys, thus forming the encrypted message.

In another embodiment of the invention, there is a device for decrypting an encrypted message, whereby the encrypted message includes communication configuration data, has a key generation unit which is able to execute an Internet-based authentication method by using at least one service from a unit in a security layer between a first communication unit and a second communication unit, so that at least one pair of cryptographic keys is formed for the first communication unit and for the second communication unit. Furthermore the device has a decryption unit which can decrypt the communication configuration data of the second communication unit by using at least one cryptographic key of the at least one pair of cryptographic keys to decrypt the encrypted message including the communication configuration data.

According to one embodiment of the invention, the Internet-based authentication method is based on an extensible authentication protocol method.

Alternatively, in another embodiment, it is possible to use any authentication method in which a pair of cryptographic keys will be formed and which will use the services of the security layer without the interposition of an IP layer. This clearly means that the Internet-based authentication method is produced at the layer 3 level according to the OSI reference model, that is, at the level of the network layer.

In other words this means that standardized configuration protocols such as those described in [5], [6], [7] or [8] are used inventively in order to configure a communication terminal, preferably a mobile radio communication terminal, or to be precise, to provide such a terminal with configuration data, which from here on will also be called communication configuration data or communication configuration parameters.

The configuration takes place in a manner not provided for in the prior art.

Clearly the standardized configuration protocols are cryptographically protected by using cryptographic keys which were formed in advance by an Internet-based authentication method, in particular preferably an EAP-based network authentication method or network authentication mechanism.

To put it another way, standardized configuration protocols such as DHCP or ModeConfig are protected by cryptographic keys formed in the context of prior network access authentication.

The communication configuration data can be transmitted from the first communication unit to the second communication unit by using electronic messages according to the Internet-based authentication method.

This embodiment of the invention has the particular advantage that the communication protocol used for authentication and key generation can now also be used in the message formats to be used for transmitting the communication configuration data from the communication network to the communication terminal, thus simplifying the implementation of the method to which the invention relates.

According to another embodiment of the invention, the communication configuration data are transmitted from the first communication unit to the second communication unit by using electronic messages according to one of the following Internet-based authentication methods
protected extensible authentication protocol method,
extensible authentication protocol tunneled TLS authentication protocol method, or
protocol for carrying authentication for network access method.

In other words the communication configuration data can be transmitted according to the method described in [20], [21] or [17].

If the EAP-based method itself is used for transmitting the communication configuration data, EAP configuration messages can be protected by means of known tunneling methods, such as those described in [20], [21] or [17], or by EAP-internal protection mechanisms as in [19]. In this connection it is also possible to use the method described in [18] as a container in order to transport the communication configuration data.

Preferably the first communication unit is a communication unit of a communication network element, for preference specifically a communication unit of a communication network element in a mobile radio communication network according to a 3GPP mobile radio standard for example, being for instance a communication network element which is set up according to UMTS or alternatively according to another mobile radio standard such as GSM.

According to another embodiment of the invention, the second communication unit is a communication terminal, for preference specifically a mobile radio communication terminal that is set up according to a mobile radio communication standard such as 3GPP, for instance according to the UMTS or GSM communication standard.

The method described above is particularly suitable in the context of transmitting configuration data over an air interface to a mobile radio communication terminal, since the communication protocols standardized in this connection can be used very simply and cost-effectively for transmitting the communication configuration parameters securely from inside of a communication network domain to a mobile radio communication terminal.

According to another embodiment of the invention, the communication configuration data is encoded according to the protocol format of a protocol for configuring a communication terminal, preferably according to the protocol format of a protocol for dynamically configuring a communication terminal, for preference specifically according to a protocol format of a dynamic host configuration protocol for dynamically configuring a communication terminal, as described in [2] for example.

Particularly in an EAP-based authentication method, using the cryptographic key material generated in the context of the EAP-based authentication method for cryptographically protected transmission of the communication configuration data in the context of a DHCP communication protocol or ModeConfig communication protocol is suitable due to its simplicity and cost-effective implementation.

Communication configuration data means in this connection all the data or parameters which characterize the communication properties of a communication terminal in the context of a communication session.

For example, communication configuration data includes data provided by means of the configuration protocol, preferably according to the dynamic host configuration protocol, for characterizing the communication terminal, for example the information provided according to the BOOTP which was prepared on the BOOTP-based server, in particular the IP address of the communication terminal, an element known as a subnet mask, an IP address of the default gateway, an IP address of the primary DNS server and/or of the secondary DNS server, an IP address of the primary WINS server or an IP address of the secondary WINS server, a path to the necessary BOOTP file, a communication network domain suffix of the client, that is, of the mobile radio communication terminal, an IP address of the time server, together with a time offset from coordinated universal time (CMT).

### BRIEF DESCRIPTION OF THE DRAWINGS

Exemplary embodiments of the invention are shown in the drawings and will be explained in greater detail below, in which:

FIG. 1 shows a communication system according to the prior art.

FIGS. show 2a to 2d are a message flow chart in which the individual method steps for transmitting communication configuration data are shown according to a first exemplary embodiment of the invention.

FIGS. 3a and 3b show a message flow chart in which the individual method steps for transmitting communication configuration data are shown according to a second exemplary embodiment of the invention.

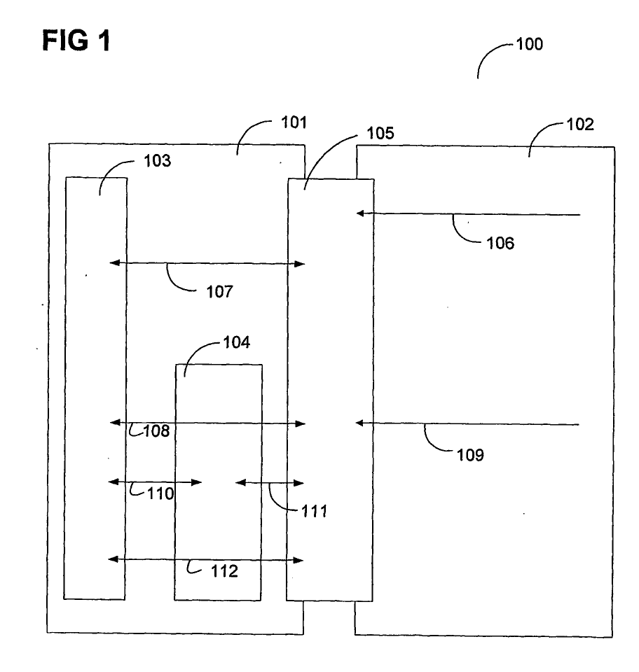

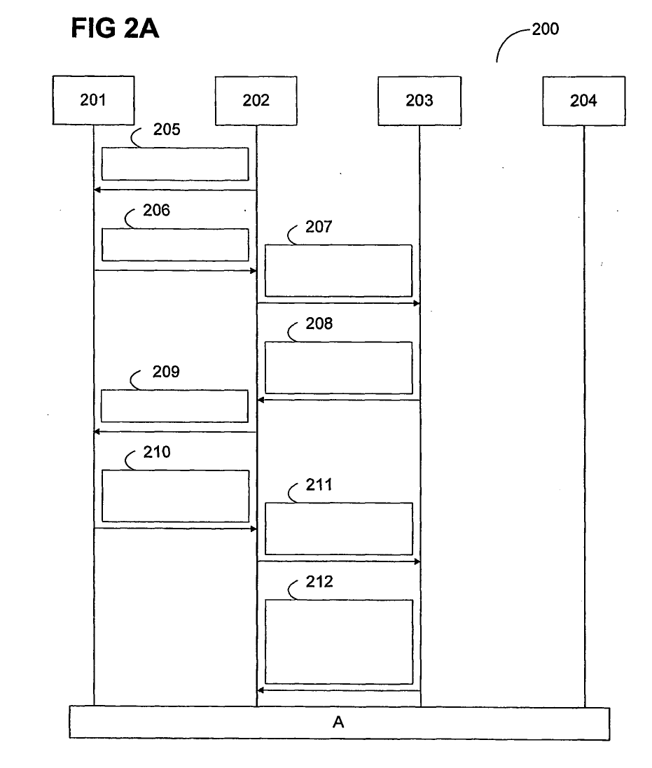

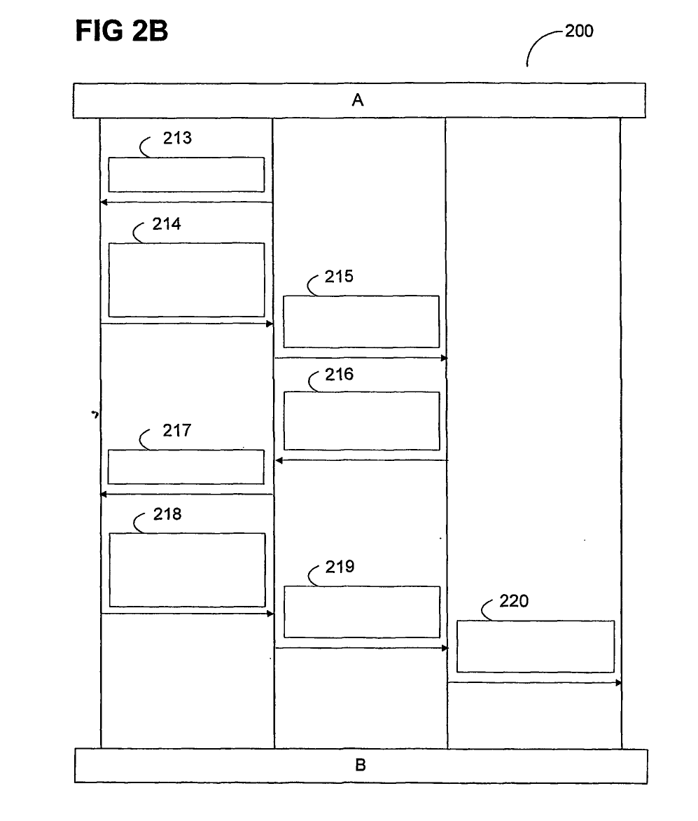

### DETAILED DESCRIPTION OF THE INVENTION

FIG. 2a to FIG. 2d show a message flow chart 200 illustrating the exchange of electronic messages between units of a mobile radio communication system set up according to the UMTS communication standard. FIG. 2a to FIG. 2d show specifically a mobile radio communication terminal 201, a wireless local area network (WLAN) access node computer 202, a TTLS server 203 and an authorization authentication and accounting unit 204 (AAA unit).

The usual further components of the mobile radio communication network according to the UMTS standard, especially the units of the core network, as well as the further mobile radio communication terminals or fixed network communication terminals that are also provided in the communication system so as to provide a communication link, are not shown in the message flow chart 200 of FIG. 2a to FIG. 2d for the sake of simplicity.

With regard to the message flow, the communication system is set up as described in [21] together with the enhancement described below.

First the method described in [21] is executed in order to establish a TLS tunnel, a unilateral authentication of the server 204 being performed on the client, which according to this exemplary embodiment is the mobile radio communication terminal 201. The message flow is essentially the same as that described in ([21] section 13.2.

Following successful establishment of the TLS tunnel in the way to be described in further detail below, an EAP/MD5 challenge authentication, in other words a unilateral authentication of the client, which according to this exemplary embodiment is the mobile radio communication terminal 201, is performed on the server 204.

As described in [21], the method begins with the access point node 202 as in [21] forming an extensible authentication protocol Request/Identity message 205 and transmitting it to the mobile radio communication terminal 201.

In reaction to this the mobile radio communication terminal 201 forms and sends an EAP Response/Identity message 206 to the access point node 202, which on receiving this message 206 forms a RADIUS Access-Request message 207 with the message parameters “XXX-Data-Cipher-Suite+” and “EAP-Response passthrough”, then transmits said message to the TTLS server 203.

On receiving the RADIUS Access-Request message 207 the TTLS server 203 forms a RADIUS Access-Challenge message 208 with the parameter EAP-Request/TTLS-Start and transmits it to the access point node 202.

On receiving the message 208 the access point node 202 forms an EAP Request passthrough message 209 and sends this to the mobile radio communication terminal 201.

On receiving the message 209 the mobile radio communication terminal 201 forms an EAP Response/TTLS message 210 with the parameter “ClientHello” as the useful data element and sends this message 210 to the access point node 202.

The access point node 202 receives the message 210 and forms a RADIUS Access-Request message 211 with the parameter “EAP-Response passthrough” as the useful data element and sends this message 211 to the TTLS server 203.

When the TTLS server 203 has received the RADIUS Access-Request message 211 and evaluated the useful data element EAP Response passthrough, the TTLS server 203 forms a RADIUS Access-Challenge message 212 and sends this to the access point node 202. The RADIUS Access-Challenge message 212 contains as useful data elements, that is, as message parameters: “EAP-Request-TTLS”, “ServerHello”, “Certificate”, “ServerKeyExchange” and “ServerHelloDone”.

As shown in FIG. 2b, on receiving the message 212 the access point node 202 forms and transmits an EAP Request passthrough message 213 to the mobile radio communication terminal 201, which then [forms], according to the method described in [21], an EAP Response/TTLS message 214 with the parameters “ClientKeyExchange”, “Change-Cipher-Spec”, “Finished” as message parameters and sends the message 214 to the access point node 202. On receiving the message 214 the node forms a RADIUS Access-Request message 215 with the message parameter “EAP-Response passthrough” and transmits this to the TTLS server 203.

When it receives the message 215 the TTLS server 203 forms a RADIUS Access-Challenge message 216 with the following message parameters: “EAP-Request/TTLS”, “Change-Cipher-Spec”, “Finished”, and sends the message 216 to the access point node 202. When the node receives the message 216 it forms an EAP Request passthrough message 217 which it transmits to the mobile radio communication terminal 201.

On receiving the message 217 the mobile radio communication terminal 201 forms in response an EAP Response/TTLS message 218 with the parameters “{EAP-Response/Identity}” and “{XXX-Data-Cipher-Suite+}”, then sends the message 218 to the access point node 202.

The access point node 202 receives the message 218 and forms a RADIUS Access-Request message 219 with the element “EAP-Response passthrough”. The message 219 is transmitted from the access point node 202 to the TTLS server 203, which on receiving the message 219 [forms] a RADIUS Access-Request message 220 with the information “EAP-Response/Identity” as the useful data element and sends the message 220 to the AAA server 204. On receiving the message 220, the server responds by forming a RADIUS Access-Challenge message 221, the message including the information “EAP-Request/MD5-Challenge” as its parameter (cf. FIG. 2c).

The message 221 is transmitted from the AAA server 204 to the TTLS server 203, which for its part on receiving the message 221 forms a RADIUS Access-Challenge message 222 including the information “EAP-Request/TTLS” as its message element together with “{EAP-Request/MD5-Challenge}” and “{XXX-Data-Cipher-Suite}” as further parameters.

The message 222 is transmitted from the TTLS server 203 to the access point node 202. When the node receives the message 222 it forms an EAP Request passthrough message 223 and transmits it to the mobile radio communication terminal.

On receiving the message 223, the mobile radio communication terminal 201 forms an EAP Response/TTLS message 224 with the information “{EAP-Response/MD5-Challenge}” and sends it to the access point node 202. On receiving this message the node forms a RADIUS Access-Request message 225 with EAP Response passthrough and transmits it to the TTLS server 203.

On receiving the message 225 the TTLS server 203 forms a RADIUS Access-Challenge message 226 with the information EAP-Response/MD5-Challenge and transmits the message 226 to the AAA server 204.

On receiving the message 226 the AAA server 204 forms a RADIUS Access-Accept message 227 and sends this to the TTLS server 203. When the server receives the message 227 it forms a further RADIUS Access-Accept message 228 with the following message parameters: “XXX-Data-Cipher-Suite”, “XXX-Data-Keying-Material”, “EAP-Success”. The message 228 is transmitted from the TTLS server 203 to the access point node 202. When the node receives the message 228 it forms an EAP Success passthrough message 229 and transmits it to the mobile radio communication terminal 201, thus arriving at a mutual authentication of the mobile radio communication terminal and the AAA server, i.e. the network.

In order to receive communication configuration data, the mobile radio communication terminal 201 transmits a configuration request message according to the DHCP protocol as CP (CFGREQUEST) being the useful data element in the protocol format described in [21] in an EAP Response/TTLS message 230 and transmits the message to the access point node 202. When the node receives the configuration request it again uses the message format described in [21] to form a RADIUS Access-Request message 231. The message 231 has a message parameter EAP Response/TTLS passthrough having in addition the information according to the DHCP message element CP(CFGREQUEST) (cf. FIG. 2d).

The message 231 transmitted by the access point node 202 to the TTLS server causes the TTLS server 203 to [lacuna] the configuration data available to and provided for the mobile radio communication terminal 201, being according to this exemplary embodiment in particular one or more dynamic IP addresses, and transmits the data, using the key material formed in the context of the authentication method as described above, in a RADIUS Access-Challenge message 232 which has as its message parameters an EAP Request/TTLS with the additional parameters according to the DHCP protocol “CP (CFG_REPLY)”, and sends said message to the access point node 202.

The access point node 202 in its turn determines from the message 232 the configuration data contained in the useful data CP (CFG_REPLY), in particular the dynamic IP address(es) provided for the mobile radio communication terminal, and sends the configuration data, in the form of the DHCP message element “CP (CFG_REPLY)” packed in an EAP Response/TTLS message 233, to the mobile radio communication terminal 201.

If the message 233 is successfully transmitted to the mobile radio communication terminal 201, the latter determines the configuration data from the message 233 and uses the data as provided for in the control program of the mobile radio communication terminal 201.

Clearly transmission of the mobile radio communication configuration data takes place after completion of the authentication according to the EAP-based authentication method described in [21]. In addition to the method described in [21] there is provision for the computer to be set up according to [7] in order to give the mobile radio communication terminal 201 the ability as client to request the communication configuration data by means of the CFG_REQUEST message and to receive same by means of the CFG_REPLY message.

Except for the message formats described as proprietary in [7] the nomenclature, the setup and the parameters are the same as the customary DHCP format as described in [3] for example.

The communication configuration data is transmitted through the established TLS tunnel in a secure cryptographic manner.

In the exemplary embodiment, the communication between the TTLS server 203 and the node which provides the configuration data, such as a DHCP server or a LDAP server, is not described in further detail in the interests of clarity.

In an alternative embodiment there is provision for the communication configuration data to be sent to the mobile radio communication terminal 201 immediately after completion of the mutual authentication, for example within the EAP Success message 229.

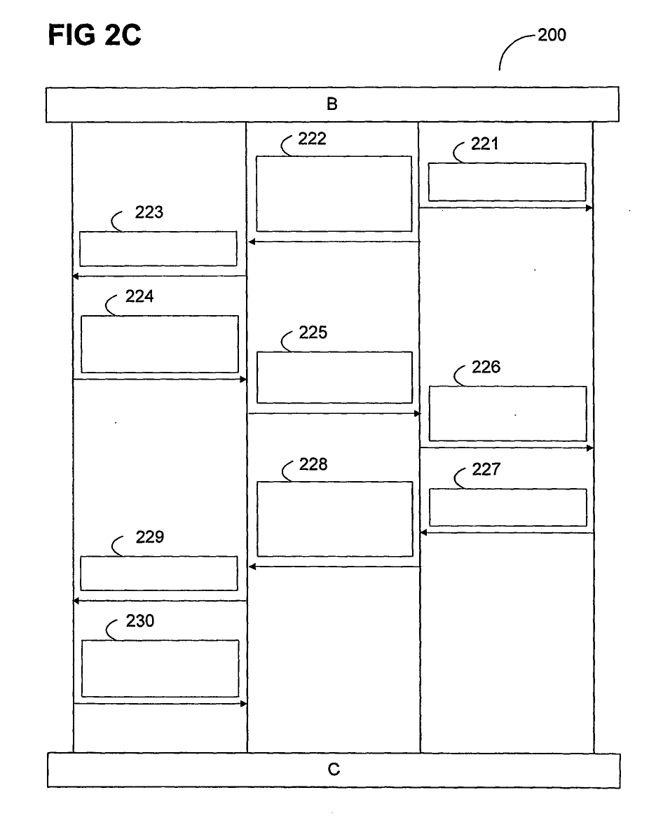

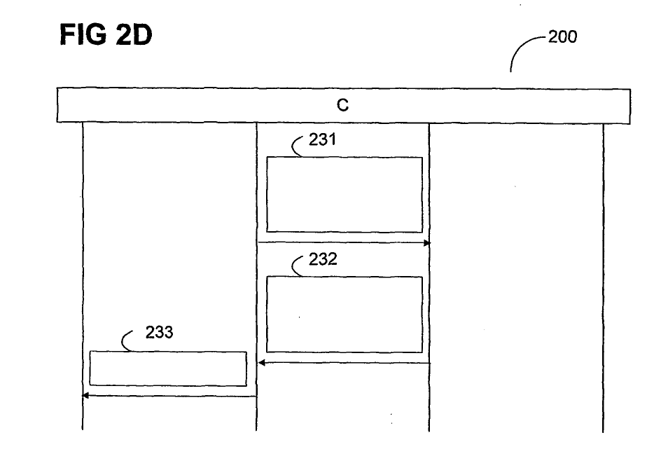

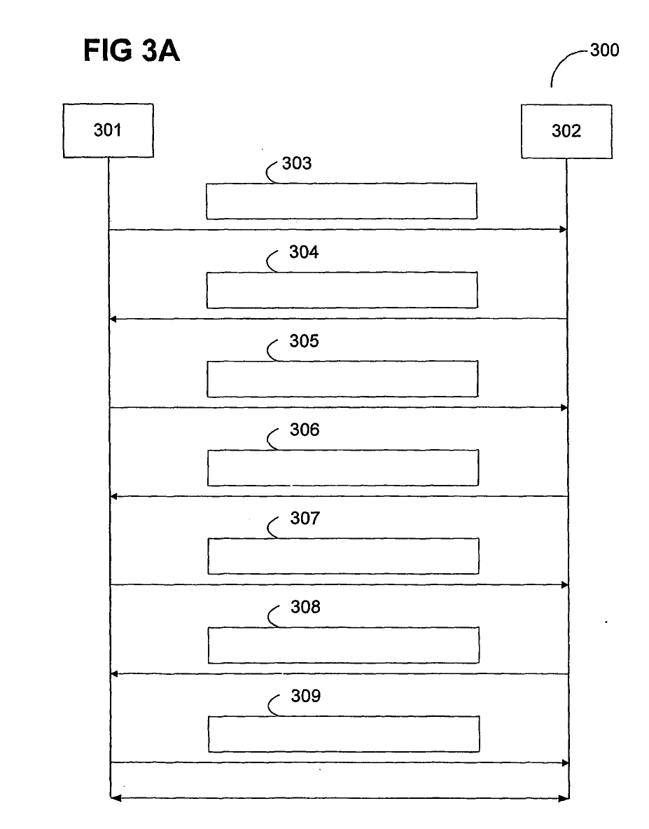

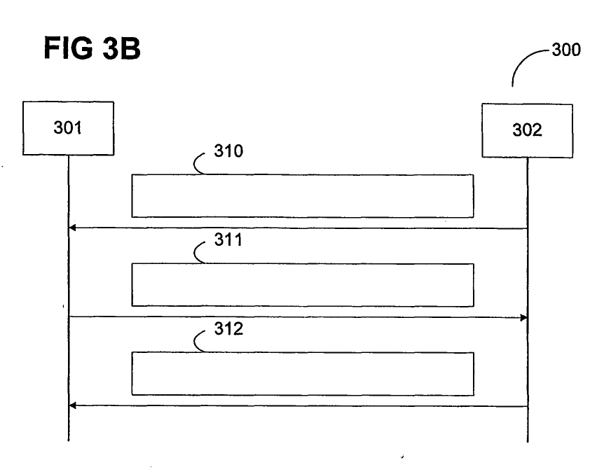

A third exemplary embodiment of the invention is shown in a message flow chart 300 in FIG. 3a and FIG. 3b.

In this exemplary embodiment the EAP-based authentication method is designed according to the PANA method as described in [17].

A PANA_Discover (0, 0) message 303 is formed by the PANA client 301 according to the protocol described in [17] and sent to the PAA server 302. On receiving the PANA_Discover (0, 0) message 303, said server forms a response message being PANA_start (x, 0) [Cookie] message 304 and transmits it to the client 301 (cf. FIG. 3a).

On receiving the message 304 the PANA client 301 forms a PANA_start (x, y) [Cookie] message 305 and transmits it to the PAA server 302. On receiving the message 305, the server reacts in the context of the EAP-based authentication method with a first authentication message 306, being PANA_auth (x+l, y) [EAP{Request}], and transmits this to the client 301.

On receiving the message 306 the client 301 forms a second authentication message 307 PANA_auth(y+l, x+l) [EAP {Response}]. The message 307 is transmitted to the PAA server 302.

On receiving the message 307 the PAA server 302 forms a third authentication message 308 PANA_auth (x+2, y+1) [EAP{Request}] and transmits it to the client 301, which for its part on receiving the message 308 forms a fourth authentication message 309 PANA_auth (y+2, x+2) [EAP{Response}] and transmits it to the PAA server, thereby establishing the PAA security association.

This method is the same as that described in [17].

Next, as also described in [17], the PAA server 302 forms a PANA acknowledgment message 310 PANA_Success(x+3, y+2) [EAP {Success}, Device-Id, Data-Protection, MAC] and transmits it to the client 301, which is preferably set up as a mobile radio communication terminal (cf. FIG. 3b).

On receiving the message 310 the client 301 forms a PANA success acknowledgment message 311 PANA_Success_ack (y+3, x+3) [Device-Id, Data-Protection, CP (CFG_Request), MAC] and sends this to the PAA server 302, which for its part, on receiving the message 311 forms a further PANA message 312 with the requested configuration data and sends it to the client 301 as PANA_msg (x+4, y+3) [CP (CFG_Reply), MAC].

Clearly the embodiment corresponds to the PANA protocol according to [17], with the enhancement that the payloads for transporting the address configuration messages according to the DHCP, or alternatively according to ModeConfig, have been extended in the context of the invention.

In FIG. 3a and FIG. 3b the payloads have also been used as configuration payloads according to [7] without restricting the general validity.

The request and response for obtaining the communication configuration data is cryptographically protected by the MAC payload, which is produced by a keyed message digest function.

The necessary cryptographic key and security parameters, that is, the cryptographic key material, or security material, are provided by the PANA security association (SA) which was generated by means of the EAP authentication, as described above and dealt with in detail in [17].

References to the following publications are included in this document:
[1] N. Prigent et al., DHCPv6 Threads, Internet-Draft, May 2001;
[2] C. Schäfer, Das DHCP-Handbuch, Ein Leitfaden zur Planung, Einführung und Administration von DHCP, (The DHCP Handbook, a Guide to the Planning, Introduction and Administration of DHCP) Edison-Wesley-Verlag, ISBN 3-8273-1904-8, pages 141-149, 2002;
[3] R. Droms, Dynamic Host Configuration Protocol, Request for Comments: 2131, March 1997;
[4] R. Droms et al., Authentication for DHCP Messages, Request for Comments: 3118, June 2001;
[5] M. Richardson, A Method for Configuration for IPsec Clients Using DHCP, Internet-Draft, February 2003;
[6] T. Kivinen, DHCP over IKE, Internet Draft, April 2003;
[7] D. Dukes, Configuration Payload, Internet Draft, July 2003;
[8] D. Dukes et al., The ISAKMP Configuration Method, Internet Draft, September 2001;
[9] D. Harkins et al., The Internet Key Exchange (IKE), Request for Comments: 2409, November 1998;
[10] C. Kaufman, Internet Key Exchange (IKEv2) Protocol, Internet Draft, April 2003;
[11] A. McAuley et al., Dynamic Registration and Configuration Protocol (DRCP),Internet Draft, Janurary 2001;
[12] B. Mukherjee et al., Extensions to DHCT for Roaming Users, Internet Draft, May 2001;
[13] S. Medvinsky et al., Kerberos V Authentication Mode for Uninitialized Clients, Internet Draft, July 2000;
[14] V. Gupta, Flexible Authentication for DHCP Messages, Internet Draft, February 2003;
[15] H. Tschofenig et al., EAP IKEv2 Method, Internet Draft, February 2004;
[16] L. Blunk et al., Extensible Authentication Protocol (EAP),Internet Draft, February 2004;
[17] D. Forsberg et al., Protocol for Carrying Authentication for Network Access (PANA), Internet Draft, May 2004;
[18] M. Grayson et al., EAP Authorization, Internet Draft, March 2003;
[19] T. Hiller et al., A Container Type for the Extensible Authentication Protocol (EAP),Internet Draft, May 2003;
[20] H. Andersson et al., Protected EAP Protocol, Internet-Draft, February 2002;
[21] P. Funk, EAP Tunnel TLS Authentication Protocol (EAP-PTLS), Internet Draft, April 2004

1. A method for forming an encrypted message including communication configuration data, comprising:
executing an Internet-based authentication method using at least one service from a unit in a security layer or link control layer between a first communication unit and a second communication unit, so that at least one pair of cryptographic keys is formed for the first communication unit and for the second communication unit; and
encrypting the communication configuration data of the first communication unit using at least one cryptographic key of the at least one pair of cryptographic keys, forming the encrypted message.

2. The method according to claim 1, wherein the Internet-based authentication method is based on an extensible authentication protocol method.

3. The according to claim 1, wherein the communication configuration data is transmitted from the first communication unit to the second communication unit by using electronic messages according to the Internet-based authentication method.

4. The method according to claim 1, wherein the communication configuration data is transmitted from the first communication unit to the second communication unit by using electronic messages according to one of the following Internet-based authentication methods:
protected extensible authentication protocol method,
extensible authentication protocol tunneled TLS authentication protocol method, or
protocol for carrying authentication for network access method.

5. The method according to claim 1, wherein the first communication unit is a communication unit of a communication network element.

6. The method according to claim 5, wherein the first communication unit is a communication unit of a communication network element in a mobile radio communication network.

7. The method according to claim 1, wherein the second communication unit is a communication terminal.

8. The method according to claim 7, wherein the second communication unit is a mobile radio communication terminal.

9. The method according to claim 1, wherein the communication configuration data is encoded according to a protocol format of a protocol for configuring a communication terminal.

10. The method according to claim 9, wherein the communication configuration data is encoded according to a protocol format of a protocol for dynamically configuring a communication terminal.

11. The method according to claim 10, wherein the communication configuration data is encoded according to a dynamic host configuration protocol for dynamically configuring a communication terminal.

12. A method for encrypting an encrypted message including communication configuration data, comprising:
executing an Internet-based authentication method using at least one service from a unit in a security layer or link control layer between a first communication unit and a second communication unit, so that at least one pair of cryptographic keys is formed for the first communication unit and for the second communication unit; and
determining communication configuration data of the second communication unit using at least one cryptographic key of the at least one pair of cryptographic keys to decrypt the encrypted message including the communication configuration data.

13. A device for forming an encrypted message, the encrypted message including communication configuration data, comprising:
a key generation unit configured to execute an Internet-based authentication method using at least one service from a unit in a security layer between a first communication unit and a second communication unit, so that at least one pair of cryptographic keys is formed for the first communication unit and for the second communication unit; and
an encryption unit configured to encrypt the communication configuration data by using at least one cryptographic key of the at least one pair of cryptographic keys, forming the encrypted message.

14. A device for encrypting an encrypted message, the encrypted message including communication configuration data, comprising:
a key generation unit configured to execute an Internet-based authentication method using at least one service from a unit in a security layer between a first communication unit and a second communication unit, so that at least one pair of cryptographic keys is formed for the first communication unit and for the second communication unit; and
a decryption unit configured to decrypt the communication configuration data of the second communication unit by using at least one cryptographic key of the at least one pair of cryptographic keys in decrypting the encrypted message including the communication configuration data.
